(19) United States
(12) Patent Application Publication
(10) Pub. No.: US 2012/0195366 A1
(43) Pub. Date: Aug. 2, 2012

(54) Method and Apparatus of Adaptive Inter Mode Coding Using Variable Length Codes

(75) Inventors: Shan Liu, San Jose, CA (US); Ximin Zhang, San Jose, CA (US); Shaw-Min Lei, Hsin-chu (TW)

(73) Assignee: MEDIATEK SINGAPORE PTE. LTD.

(21) Appl. No.: 13/108,055

(22) Filed: May 16, 2011

Related U.S. Application Data
(60) Provisional application No. 61/438,349, filed on Feb. 1, 2011.
(60) Provisional application No. 61/447,763, filed on Mar. 1, 2011.

(51) Int. Cl. H04N 7/26

(52) U.S. Cl. 375/240.02; 375/E07.126

(57) ABSTRACT

A method and apparatus for adaptive inter prediction mode coding are disclosed. In the current HEVC, a fixed set of variable length codes is used for the underlying video data, which may not optimally match the statistics of underlying video data. Consequently, the compression efficiency associated with the fixed set of variable length codes will be compromised. Accordingly, an adaptive coding scheme for inter prediction modes is disclosed. The variable length codes used for each inter prediction mode in each coding unit depth is adaptively determined by its respective statistics. The statistics can be measured as the frequency of occurrence of each mode. In one embodiment according to the present invention, counters are used to collect the statistics. According to one embodiment of the present invention, the statistics of inter prediction modes are collected from the previous slice and the set of variable length codes is determined for the subsequent slice (immediately following the previous slice) accordingly. According to another embodiment of the present invention, the statistics of inter prediction modes are updated for each coding unit and the variable length code for each mode is adjusted according to the statistics change during the coding process. According to another embodiment of the present invention, the variable length code for each mode is reset in the beginning of each slice. The reset code word table is either a predefined code word table for whole sequence or a code word table determined by the previous slice.

### CROSS REFERENCE TO RELATED APPLICATIONS

The present invention claims priority to U.S. Provisional Patent Application Ser. No. 61/438,349, filed Feb. 1, 2011, entitled “Adaptive Inter Mode Coding Design for Efficient Inter Slice Coding” and U.S. Provisional Patent Application Ser. No. 61/447,763, filed Mar. 1, 2011, entitled “Counter-based adaptive Inter mode coding”. The U.S. Provisional Patent Applications are hereby incorporated by reference in their entireties.

### FIELD OF THE INVENTION

The present invention relates to video coding. In particular, the present invention relates to coding techniques associated with the inter prediction mode.

### BACKGROUND

In advanced coding systems such as H.264/AVC and High Efficiency Video Coding (HEVC), flexible inter prediction has been used that offers more choices of prediction modes such as SKIP, DIRECT, INTER and INTRA modes. While H.264/AVC performs motion estimation and compression on the macroblock basis, HEVC introduces a new unit for coding—Coding Unit (CU). The coding unit can start with a largest coding unit (LCU) and the LCU is adaptively divided into smaller blocks using quadtree structure to achieve better performance. Blocks that are no longer split into smaller coding units are called leaf CUs. The quadtree split can be recursively applied to each of the largest CU until it reaches a leaf CU or a smallest CU. The sizes of the largest CU and the smallest CU are properly selected to balance the tradeoff between system complexity and performance. Since the CU may be split into smaller CUs, the INTER mode in HEVC allows four possible partitions of a coding unit and the corresponding INTER prediction modes are named INTER_{—}2N×2N, INTER_{—}2N×N, INTER_N×2N, and INTER_N×N modes. On the other hand, the INTRA mode allows two possible partitions of the coding unit and the corresponding INTRA prediction modes are named INTRA_{—}2N×2N and INTRA_N×N modes. Furthermore, MERGE mode is also used in HEVC to allow neighboring coding units to share the same motion information. In addition there is a syntax element, SPLIT used in HEVC to indicate whether a coding unit is split into smaller units or not. Consequently, a coding unit in the B-slice/P-slice may have a large selection of inter prediction modes and information associated with these inter prediction modes has to be conveyed to the decoder so that the decoding can be properly performed. During the development of HEVC, a fixed set of variable length codes is used for the underlying video data, which may not achieve good coding efficiency for the inter prediction modes. It is desirable to develop an adaptive coding scheme for inter prediction modes that can dynamically adapt to the characteristics of the underlying video data. Furthermore, it is desirable that the adaptive scheme can take into consideration of different characteristics of inter prediction modes at different coding unit depths.

### BRIEF SUMMARY OF THE INVENTION

A method and apparatus for coding inter prediction mode of a coding unit are disclosed. In one embodiment according to the present invention, the method and apparatus for coding inter prediction modes of a coding unit comprise steps of receiving inter prediction modes corresponding to coding units in a video data set, wherein the inter prediction modes belong to a prediction mode set consisting of a group of mode names; collecting statistics of the inter prediction modes associated with a selected set of mode names; determining a set of variable length codes for the selected set of mode names according to the statistics; and providing coded representation for each of the inter prediction modes by selecting one of the variable length codes corresponding to the mode name of said each of the inter prediction modes if the mode name of said each of the inter prediction modes belongs to the selected set of mode names. In another embodiment of the invention, the method and apparatus further comprise steps of determining a pre-defined set of variable length codes is used for the inter prediction modes belonging to a second set of mode names, wherein the second set of mode names includes remaining mode names of the group of mode names that do not belong to the selected set of mode names; and providing the coded representation for said each of the inter prediction modes by selecting one of the pre-defined set of variable length codes corresponding to the mode name of said each of the inter prediction modes if the mode name of said each of the inter prediction modes belongs to the second set of mode names.

In one aspect of the invention, the statistics are based on occurrence frequencies of the inter prediction modes, and the occurrence frequencies are collected using counters where a counter is associated with each of the selected set of mode names. The counters may be reset substantially at the beginning of a current video data set or at the end of a previous video data set. In one embodiment, when the counters are reset, the set of variable length codes may be set to a pre-defined table. When the count for one prediction mode exceeds the count of a next prediction mode with shorter length, the two codes are swapped. In another embodiment of the invention, the statistics are based on counts of consecutive occurrences of the selected set of mode names corresponding to the inter prediction modes using counters. The selected set of mode names may include all possible mode names or only a subset. In yet another embodiment according to the invention, separate adaptive variable length codes are designed for prediction modes at each coding unit depth. The set of variable length codes may correspond to a set of codes generated using a unary codeword method. In another aspect, various side information and flags are incorporated in the slice header, PPS (Picture Parameter Set) or SPS (Slice Parameter Set) to convey needed information to the decoder.

A method and apparatus for decoding inter prediction mode of a coding unit are disclosed. In one embodiment according to the present invention, the method and apparatus for decoding inter prediction mode of a coding unit comprise steps of determining a selected set of mode names from a bitstream, such as from a slice header, PPS or SPS; determining a set of variable length codes for the selected set of mode names from the bitstream; receiving coded representation for an inter prediction mode of a coding unit, wherein the inter prediction mode belong to a prediction mode set consisting of a group of mode names and the group of mode names includes the selected set of mode names; decoding the coded representation into the inter prediction mode according to the set of variable length codes if the coded representation belongs to the set of variable length codes; and updating the set of variable length codes for every coding unit, largest coding unit or a group of coding units according to the inter prediction mode decoded if the coded representation belongs to the set of variable length codes. In another embodiment of the invention, the method and apparatus further comprise steps of determining a pre-defined set of variable length codes for a second set of mode names corresponding to remaining mode names of the group of mode names that do not belong to the selected set of mode names; and decoding the coded representation into the inter prediction mode according to the pre-defined set of variable length codes if the coded representation belongs to the pre-defined set of variable length codes.

### BRIEF DESCRIPTION OF THE DRAWINGS

FIG. 1 illustrates the syntax elements used in the coding unit level for coding inter prediction modes according to High Efficiency Video Coding (HEVC).

FIG. 2 illustrates an exemplary flow chart for coding the inter prediction mode according to one embodiment of the present invention.

FIG. 3 illustrates an alternative exemplary chart for coding the inter prediction mode according to one embodiment of the present invention.

FIG. 4 illustrates an exemplary flow chart for decoding the inter prediction mode according to one embodiment of the present invention.

FIG. 5 illustrates an alternative exemplary chart for decoding the inter prediction mode according to one embodiment of the present invention.

### DETAILED DESCRIPTION OF THE INVENTION

In video coding systems, the spatial and temporal redundancy is exploited using spatial and temporal prediction to reduce the size of video bitstream to be transmitted or stored. The spatial prediction utilizes decoded pixels from the same picture to form prediction for current pixels to be coded. The spatial prediction is often operated on a block by block basis, such as 16×16 or 4×4 block for luminance signal in H.264/AVC intra coding. In video sequences, neighboring pictures often bear great similarities, and simply using picture differences can effectively reduce the transmitted information associated with static background areas. Nevertheless, moving objects in the video sequence may result in substantial residues and requires higher bitrate to code the residues. Consequently, Motion Compensated Prediction (MCP) is often used to exploit temporal correlation in video sequences.

Motion compensated prediction can be used in a forward prediction fashion, where a current picture block is predicted using a decoded picture or pictures that are prior to the current picture in the display order. In addition to forward prediction, backward prediction can also be used to improve the performance of motion compensated prediction. Backward prediction utilizes a decoded picture or pictures after the current picture in the display order. Both forward prediction and backward prediction exploit correlation between pictures and the associated coding technique is referred to an inter coding. The unit used for motion estimation in earlier video standards such as MPEG-1, MPEG-2 and MPEG-4 is primarily based on the macroblock. For H.264/AVC, the 16×16 macroblock is used which can be segmented into 16×16, 16×8, 8×16 and 8×8 blocks for motion estimation. Furthermore, the 8×8 block can be further segmented into 8×8, 8×4, 4×8 and 4×4 blocks for motion estimation. For the High Efficiency Video Coding (HEVC) standard under development, the unit for motion estimation/compensation mode is called Prediction Unit (PU), where the PU is hierarchically partitioned from a maximum block size. The MCP type is selected for each slice in the H.264/AVC standard.

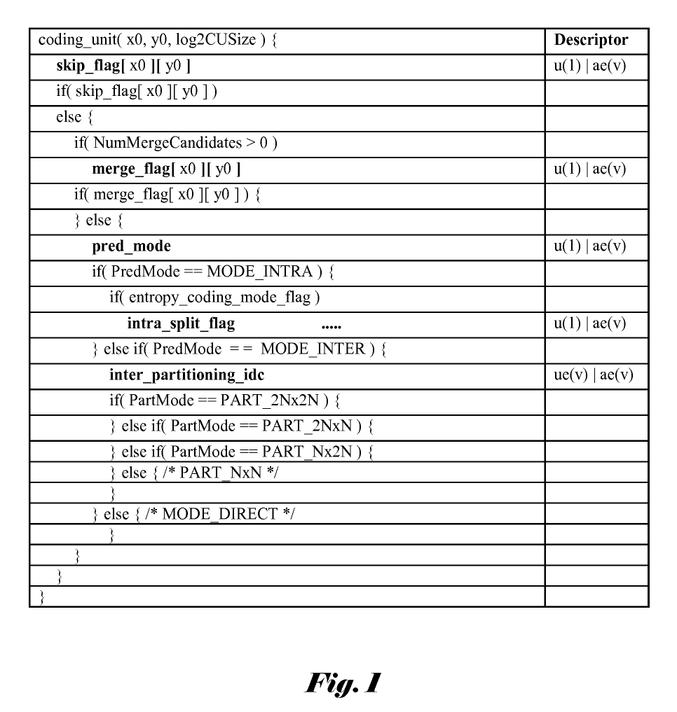

In the H.264/AVC standard, there is also SKIP mode in additional to the conventional INTRA and INTER modes for macroblocks in a P slice. The SKIP mode is a very effective method to achieve large compression since there is no quantized residue, no motion vector, nor reference index parameter to be transmitted. The only information required for the 16×16 macroblock in the SKIP mode is a signal to indicate the SKIP mode being selected and therefore substantial bitrate reduction is achieved. In the H.264/AVC standard, DIRECT mode is also supported, where the DIRECT prediction mode is inferred from previously transmitted syntax elements. Therefore, there is no need to transmit information for motion vector in the DIRECT mode. Therefore, there are four types of prediction modes in H.264/AVC including SKIP, DIRECT, INTER and INTRA modes. While H.264/AVC performs compression on the macroblock basis, HEVC introduces a new unit for coding—Coding Unit (CU). The coding unit can start with a largest coding unit (LCU) and the LCU is adaptively divided into smaller blocks using quadtree structure to achieve better performance Blocks that are no longer split into smaller coding units are called leaf CUs. The quadtree split can be recursively applied to each of the largest CU until it reaches a leaf CU or the smallest CU. The sizes of the largest CU and the smallest CU are properly selected to balance the tradeoff between system complexity and performance. In HEVC, the B-picture/P-picture type decision is made at the slice level and accordingly the slice is referred to as a B-slice/P-slice. Furthermore, in HEVC, INTER mode allows four possible partitions of the coding unit and the corresponding INTER prediction modes are named INTER_{—}2N×2N, INTER_{—}2N×N, INTER_N×2N, and INTER_N×N modes. On the other hand, in HEVC, the INTRA mode allows two possible partitions of the coding unit and the corresponding INTRA prediction modes are named INTRA_{—}2N×2N and INTRA_N×N modes. Accordingly, the coding unit in the B-slice/P-slice may be coded using SKIP, MERGE, DIRECT, INTER_{—}2N×2N, INTER_{—}2N×N, INTER_N×2N, INTER_N×N, INTRA_{—}2N×2N, and INTRA_N×N modes. The MERGE mode is another mode supported in HEVC to allow neighboring blocks to share the same motion parameters. The information associated with the selected coding mode for the coding unit is incorporated in the video bitstream using syntax designed for the system. For example, according to a draft HEVC standard, the syntax for coding unit is shown in FIG. 1 (JCTVC-E603, authored by Wiegand et. al., entitled “WD1: Working Draft 1 of High-Efficiency Video Coding”, Joint Collaborative Team on Video Coding (JCT-VC) of ITU-T SG16 WP3 and ISO/IEC JTC1/SC29/WG11, 5th Meeting: Geneva, CH, 16-23 March, 2011)

According to the syntax shown in FIG. 1 (updated), the flag for CU splitting decision, i.e. split_coding_unit_flag is always checked first. If the CU is decided not to further split, then the SKIP mode, i.e. the skip_flag is checked. If SKIP mode is selected, two bits are used for the coding unit syntax. If SKIP mode is not selected, the flag for pred_mode is checked, where pred_mode specifies prediction mode of the current coding unit. The semantics of pred_mode depend on the slice type. Name association with pred_mode, PredMode, is defined in Table 1 according to JCTVC-E603.

TABLE 1

| slice_type | pred_type | IntraSplitFlag | PredMode | PartMode |
|---|---|---|---|---|
| I | 0 | 0 | MODE_INTRA | PART_2N×2N |
| | 1 | 1 | MODE_INTRA | PART_N×N |
| P or B | 0 | — | MODE_INTER | PART_2N×2N |
| | 1 | — | MODE_INTER | PART_2N×N |
| | 2 | — | MODE_INTER | PART_N×2N |
| | 3 | — | MODE_INTER | PART_N×N |
| | 4 | 0 | MODE_INTRA | PART_2N×2N |
| | 5 | 1 | MODE_INTRA | PART_N×N |
| | inferred | — | MODE_SKIP | PART_2N×2N |

According to the coding tree syntax and coding unit syntax shown in FIG. 1, there will be at least one bit required to specify whether the coding unit will be further split. There will also be at least one bit required to specify whether the coding unit will be skipped (i.e. SKIP mode). Furthermore, there is at least one bit required to specify whether the prediction unit uses MERGE mode. Therefore, at least 4 bits (for CAVLC) will be needed for any Inter prediction mode after SPLIT and SKIP modes since two bits have been used for checking SPLIT and SKIP modes. The names associated with partition type according to JCTVC-E603 are shown in Table 2. When partition indicates 2N×2N mode (PART_{—}2N×2N) the corresponding block is coded using INTER_{—}2N×2N mode. Similarly, when partition indicates 2N×N mode (PART_{—}2N×N) the corresponding block is coded using INTER_{—}2N×N mode and so on. In HEVC, “1” is used to indicate 2N×2N partition. If 2N×2N partition type is selected and the entropy coding mode is CAVLC, there will be one bit after the 2N×2N partition type required to specify whether the MERGE mode is used. If the 2N×2N partition type is not selected, then “01” is used to indicate 2N×N partition, “001” is used to indicate N×2N partition, “0000” and “0001” are used to indicate the INTRA modes (INTRA_MODE) corresponding to INTRA_{—}2N×2N and INTRA_N×N respectively when the coding unit is greater than SCU. Instead, if the coding unit is an SCU, then “001” is used to indicate N×2N partition, and “0001” is used to indicate N×N partition, and “00000” and “00001” are used to indicate the INTRA modes (INTRA_MODE) corresponding to INTRA_{—}2N×2N and INTRA_N×N respectively.

TABLE 2

| | Name of |
|---|---|
| | inter_partioning_idc |
| inter_partioning_idc | (PartMode) |
| 0 | PART_2N×2N |
| 1 | PART_2N×N |
| 2 | PART_N×2N |
| 3 | PART_N×N |

According to the above analysis, at least three bits are already used for SPLIT, SKIP mode and PredMode checking. Therefore, with MERGE mode option put in front of Inter_{—}2N×2N, at least four bits will be used for 2N×2N if it is selected, at least five bits will be used for 2N×N if it is selected, at least six bits will be used for N×2N if it is selected and at least seven bits will be used for N×N if it is selected. Based on the above analysis, the number of syntax bits will be used for each mode in coding unit level is shown in Table 3.

TABLE 3

| | Split | Skip | Merge_2Nx2N | Inter_2Nx2N | Inter_2NxN | Inter_Nx2N | Inter_NxN | INTRA_2Nx2N | INTRA_NxN |
|---|---|---|---|---|---|---|---|---|---|
| Bits | 1 | 2 | 3 | 4 | 5 | 6 | 7 | 8 | 9 |

According to the principle of optimal variable length code design, the variable length codes are designed by assigning the codes of various lengths to underlying symbols based on the statics of the underlying symbols. The symbol with the highest probability should be allocated with the shortest codeword. Therefore, if the probability of the mode occurrences in the P/B frame or slice follows the order of Table 3 from left to the right, the current syntax coding is optimal. Otherwise, the coding efficiency can be improved by re-arranging the modes according to the corresponding statistics. In other words, the variable length code design according to Table 3 will achieve the best coding efficiency if SPLIT mode has the highest probability; SKIP mode has the second highest probability and so on. The fixed design is only optimal when the inter prediction modes of underlying video data have statistics matched with the variable length codes in Table 3. Nevertheless, different video data may result in different statistics. Even for the same sequence, a portion of the sequence may have different statistics from another portion of the sequence. Therefore, the static variable length codes as shown in Table 3 do not exploit the dynamic characteristics of a sequence and may not achieve the best performance. Accordingly, an adaptive variable length code design scheme is disclosed to improve the coding efficiency. Furthermore, it is desirable that the adaptive scheme can take into consideration of different characteristics of inter prediction modes at different coding unit depths.

In the current HEVC design, the coding unit is adaptively split from the largest coding unit (LCU) according to a quadtree. If the splitting will lead to better R-D (Rate-Distortion) performance, the coding unit is split. Otherwise the coding unit is not split. When the coding unit reaches a leaf CU or the smallest coding unit (SCU) size, the coding unit is not subject to any further splitting. Accordingly, the coding units in a slice may have different depths. If the coding unit size is equal to the LCU (largest coding unit), the depth is designated as zero. With the decrease of the coding unit size, the corresponding depth is increased until the smallest coding unit (SCU) size is reached, which is defined as 8×8 in the current HEVC draft. In an embodiment according to the present invention, the set of variable length codes is designed for inter prediction modes at each coding unit depth. The depth of coding unit is designated as “uiDepth” and coding syntax design for “uiDepth” is shown in Table 5.

TABLE 5

| | Coding syntax |
|---|---|
| SPLIT[uiDepth] | Syntax[Index (SPLIT[uiDepth])] |
| SKIP[uiDepth] | Syntax[Index (SKIP [uiDepth])] |
| MERGE_2N×2N[uiDepth] | Syntax[Index (MERGE_2N×2N [uiDepth])] |
| INTER_2N×2N[uiDepth] | Syntax[Index (INTER_2N×2N [uiDepth])] |
| INTER_2N×N [uiDepth] | Syntax[Index (INTER_2N×N [uiDepth])] |
| INTER_N×2N [uiDepth] | Syntax[Index (INTER_N×2N [uiDepth])] |
| INTER_N×N [uiDepth] | Syntax[Index (INTER_N×N [uiDepth])] |
| INTRA_2N×2N [uiDepth] | Syntax[Index (INTRA_2N×2N [uiDepth])] |
| INTRA_N×N [uiDepth] | Syntax[Index (INTRA_N×N [uiDepth])] |

In the above table, the value of Index( ) is from 0 to the number of total coding modes (flags) minus one. For example, when there are nine different inter coding flags in the coding unit level, the value of Index( ) will be from 0 to 8. According to an embodiment of the present invention, a smaller index will use a shorter codeword and a larger index will use a longer codeword. The corresponding codeword for Index( ) value is shown in Table 6, where the codes are designed using a unary coding method. The variable length codes in Table 6 are illustrated as an example and other variable length codes may also used.

TABLE 6

| | Coding word syntax |
|---|---|
| Syntax[0] | 1 |
| Syntax[1] | 01 |
| Syntax[2] | 001 |
| Syntax[3] | 0001 |
| Syntax[4] | 00001 |
| Syntax[5] | 000001 |
| Syntax[6] | 0000001 |
| Syntax[7] | 00000001 |
| Syntax[8] | 00000000 |

By using the above syntax design, each mode may adaptively select the codeword based on the index value of the mode. For example, if Index(SPLIT[uiDepth])]=0, the SPLIT mode for a coding mode with depth “uiDepth” will use “1” as the codeword. If Index(SPLIT[uiDepth])]=2, the SPLIT mode for a coding mode with depth “uiDepth” will use “001” as the codeword. Therefore, the variable length code deign according to the present invention allows a separate set of variable length codes adaptively selected to code the inter prediction modes according to the coding unit depth.

In the adaptive variable length coding design for HEVC according to an embodiment of the present invention, the variable length codes are adaptively designed for a selected set of prediction modes based on the statistics of the inter prediction modes. The statistics of the inter prediction modes may be measure by the mode occurrence frequencies of the inter prediction modes, the counts of consecutive occurrences of the inter prediction modes, or other measurement related to the characteristics of the inter prediction modes. In the case that the statistics are measured by occurrence frequencies of the inter prediction modes. The occurrence frequencies serve as probability estimation of underlying coding mode syntax, such as SKIP, pred_mode and MERGE. Another syntax, SPLIT that refers to the syntax element indicating whether a coding unit is split or not, can also be included in the mode names of the inter prediction modes for improved coding efficiency.

In one embodiment of the present invention, the variable length codes are adaptively changed with the update of the statistics within the slice. The statistics (mode occurrence frequency) for each prediction mode may be implemented by a counter, where the counter is incremented by 1 every time when the corresponding mode syntax occurs. The counter may be reset for each video data set, where the video data set may be a slice, a group of slices, frame/picture, a group of picture or any pre-defined video interval depending on the desired adaptivity. In practice, the counters can be reset at the beginning of each video data set or at the end of a previous video data set. When the counters are reset, they can be reset to a pre-defined value. While a pre-defined value of zero may be used, other integers may also be used. Furthermore, the counters may be reset to different values that may represent typical statistics of underlying video data. Accordingly, the “Index[ ]” value in Table 5 represents the ranking of the counter values of the corresponding inter prediction modes. The higher the counter value, the lower the “Index[ ]” value. For instance, the “Index[ ]” value for the prediction mode with the highest count will be zero. The selected set of prediction modes may include all allowed inter prediction modes or just a subset of allowed inter prediction modes. For example, the multiple prediction modes may include all modes shown in Table 3. Alternatively, only a subset of the mode names, such as only SPLIT, SKIP, and MERGE_{—}2N×2N modes may be included in the selected set of mode names. In one example, the pred_mode is further classified into six different modes: INTER_{—}2N×2N, INTER_{—}2N×N, INTER_N×2N, INTER_N×N, INTRA_{—}2N×2N, and INTRA_N×N, and a counter for each mode can be used to collect the mode occurrence frequencies. The pred_mode coding word syntax for the six modes can be designed according to the counts of respective modes. When the selected set of inter prediction modes only includes a subset of all possible inter prediction modes, the remaining modes not included in the subset may use the conventional static variable length codes where the codes are not adaptively updated. Using a subset of the inter prediction modes for adaptive variable length codes may reduce the system complexity/cost associated with collecting the mode occurrence frequencies and determining the set of variable length codes. When a subset is used, a better coding efficiency may be accomplished by including more frequent inter prediction modes in the subset. However, if some inter prediction modes always have the highest occurrence frequencies, these most frequent inter prediction modes do not need to be included in the subset.

In one example, the subset may include SPLIT, SKIP, INTER_{—}2N×2N, and MERGE_{—}2N×2N modes corresponding to the coding word syntax of “split coding unit flag”, “skip flag”, a portion of the “pred_mode” and “merge”. Each mode has a corresponding counter and the codeword length of these 4 modes depends on the occurrence frequency. The remaining modes for the above example, i.e., INTER_{—}2N×N, INTER_N×2N, INTER_N×N, INTRA_{—}2N×2N, and INTRA_N×N, may use a fixed set of codewords. For example, if unary codes with nine codewords are used, the first four shorter codes can be used for SPLIT, SKIP, INTER_{—}2N×2N, and MERGE_{—}2N×2N modes and the longer five codewords can be used for the remaining modes. The first four shorter codewords can be adaptively re-arranged according to the statistics of the selected set of mode names. The longer five codewords are fixed for the remaining modes and there is no need to count the occurrence frequencies of the remaining modes. However, the codewords for these modes can also be dynamically adjusted by “instant swapping”. The instant swapping forces two neighboring codewords corresponding to two inter prediction modes to swap when one of the two neighboring codewords having a longer codeword is received.

In the above embodiment, a fixed initial codeword table is used in the beginning of each slice. When the counts for underlying inter prediction modes is updated, a set of optimal variable length codes can be determined or updated accordingly. The set of variable length codes may be updated every time when a new inter prediction mode for the coding unit is processed. Alternatively, the set of variable length codes may be updated for every largest CU or a group of CUs.

In another embodiment, a content dependent initial codeword table is used in the beginning of each slice. In one embodiment of this invention, the structure of the variable length codes of the previous slice is communicated to the decoder side so that the coded inter prediction modes can be properly recovered. The optimal variable length codes matched with the statistics of underlying video data may require too much side information to communicate to the decoder. Alternatively, variable length codes with a fixed structure can be used. For example, unary codes for a given number of symbols can be used for the inter prediction modes. If there are eight inter prediction modes to be included in the adaptive code design, the set of unary codes, {1, 01, 001, 0001, 00001, 000001, 0000001, and 00000001} can be used. There is very small amount of information needed to convey the structure of this set of codes. According to order of mode occurrence counts, the codes can be assigned to the inter prediction modes. In other words, the new variable length codes are designed by re-arranging the index associated with the order of mode occurrence counts.

In the encoder side, the index value for the coding unit mode at different depth is determined slice by slice. The inter prediction mode of the coding unit is then entropy coded with the syntax coding table corresponding to the determined index value of the mode. In other words, the set of variable length codes is determined via the index table. Therefore, an index table is generated for each slice for each coding unit depth. Multiple index tables will be generated for each slice corresponding to various depths of coding units in the slice. These index tables can be entropy coded to conserve bandwidth require. The index tables can be incorporated in the slice header and sent to the decoder. Typically, there are four different depth selections for the coding unit corresponding to coding unit sizes 64×64, 32×32, 16×16, and 8×8. Therefore, up to four different index table designs will be generated for each slice.

In the decoder side, the index tables can be recovered from the information transmitted in the bitstream. In the case that the index tables are entropy coded and incorporated in the slice header, PPS or SPS, the index tables can be recovered by extracting the information from the slice header and decoded using entropy decoding. The corresponding syntax coding scheme used in the current slice can also be recovered in the decoder. The entropy decoding for the inter prediction mode of each coding unit is then performed by using the corresponding index tables for the current slice. The above process is repeated slice by slice.

In the above description, an embodiment according to the present invention uses nine different modes as an example. The present invention is not restricted to any particular number of modes and can be applied to the encoding with any number of modes. For example, if INTER_N×N and INTRA_N×N are removed, the corresponding coding syntax design for coding unit with depth “uiDepth” and syntax coding table with different index value are shown in Table 7 and Table 8 respectively.

TABLE 7

| | Coding Syntax |
|---|---|
| SPLIT[uiDepth] | Syntax[Index (SPLIT[uiDepth])] |
| SKIP[uiDepth] | Syntax[Index (SKIP [uiDepth])] |
| MERGE[uiDepth] | Syntax[Index (MERGE [uiDepth])] |
| INTER_2N×2N[uiDepth] | Syntax[Index (INTER_2N×2N [uiDepth])] |
| INTER_2N×N [uiDepth] | Syntax[Index (INTER_2N×N [uiDepth])] |
| INTER_N×2N [uiDepth] | Syntax[Index (INTER_N×2N [uiDepth])] |
| INTRA_2N×2N [uiDepth] | Syntax[Index (INTRA_2N×2N [uiDepth])] |

TABLE 8

| | Codeword Syntax |
|---|---|
| Syntax[0] | 1 |
| Syntax[1] | 01 |
| Syntax[2] | 001 |
| Syntax[3] | 0001 |
| Syntax[4] | 00001 |
| Syntax[5] | 000001 |
| Syntax[6] | 000000 |

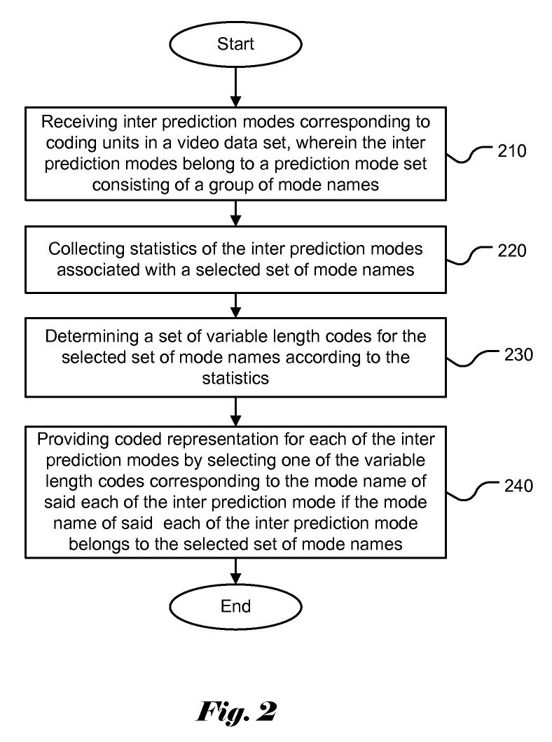

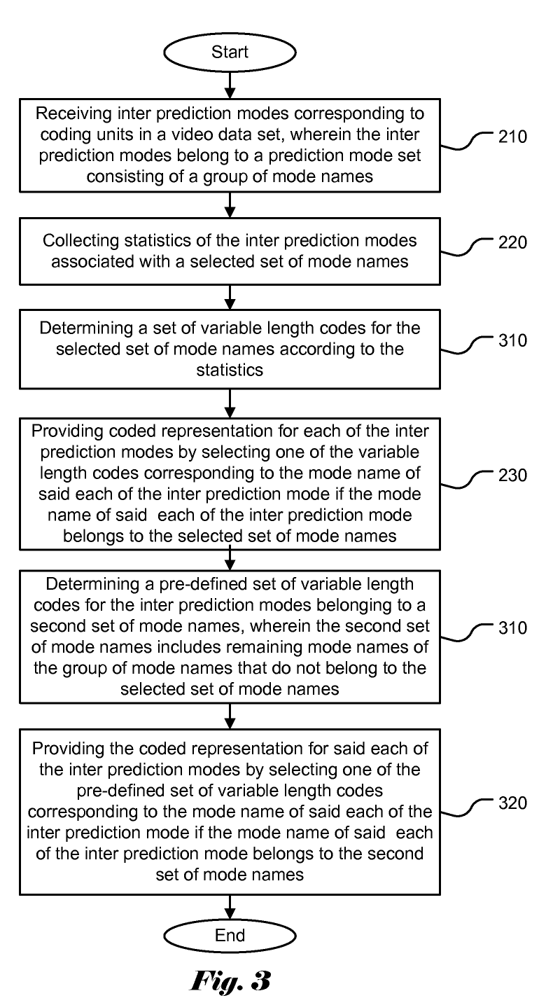

FIG. 2 illustrates an exemplary flow chart to practice the adaptive coding for inter prediction mode according to one embodiment of the present invention. The method starts with receiving inter prediction modes corresponding to coding units in a video data set as shown in step 210. The inter prediction modes belong to a prediction mode set consisting of a group of mode names. In step 220, statistics of the inter prediction modes associated with a selected set of mode names are collected. The statistic collection may be implemented using respective counters to count the mode occurrence frequencies. A set of variable length codes for the selected set of mode names according to the statistics is determined in step 230. Coded representation for each of the inter prediction modes is then provided in step 240. One of the variable length codes corresponding to the mode name of each inter prediction mode is selected as the coded representation if the mode name of each inter prediction mode belongs to the selected set of mode names. FIG. 3 illustrates an alternative exemplary chart for coding the inter prediction mode according to one embodiment of the present invention. Two additional steps are incorporated in FIG. 3 to handle the case that the inter prediction mode does not belong to the selected set of mode names. In step 310, a pre-defined set of variable length codes for the inter prediction modes belonging to a second set of mode names is determined. The second set of mode names includes remaining mode names of the group of mode names that do not belong to the selected set of mode names. In step 320, the coded representation for each of the inter prediction modes is provided. One of the pre-defined set of variable length codes corresponding to the mode name of each of the inter prediction modes is selected if the mode name of each of the inter prediction modes belongs to the second set of mode names. The steps illustrated in the flow charts of FIG. 2 and FIG. 3 are examples to practice the invention. The processing order of the steps in FIG. 2 and FIG. 3 may be altered to practice the present invention. For example, steps 220 and 230 may be performed after a current inter prediction mode is coded in step 240.

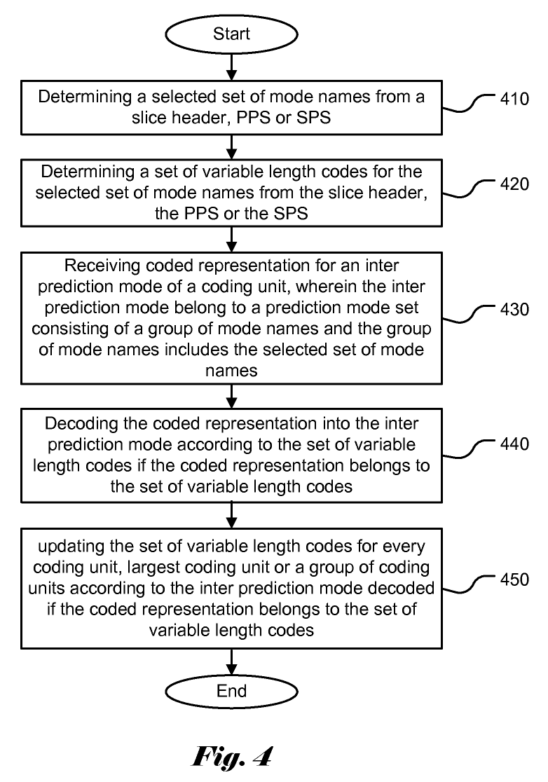

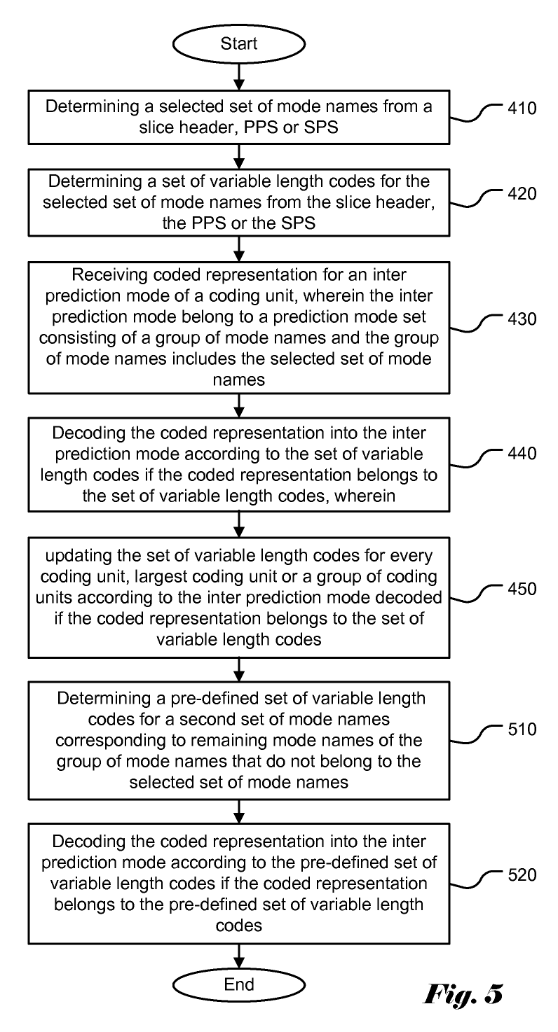

FIG. 4 illustrates an exemplary flow chart to practice adaptive decoding for the inter prediction mode according to one embodiment of the present invention. The method starts with determining a selected set of mode names in step 410, followed by determining a set of variable length codes for the selected set of mode names in step 420 from the slice header, the PPS or the SPS. In step 430, coded representation for an inter prediction mode of a coding unit is received. The inter prediction mode belong to a prediction mode set consisting of a group of mode names and the group of mode names includes the selected set of mode names. Then, the coded representation into the inter prediction mode according to the set of variable length codes is decoded in step 440 if the coded representation belongs to the set of variable length codes. After the inter prediction mode is decoded, the set of variable length codes for every coding unit, largest coding unit or a group of coding units according to the inter prediction mode decoded is updated in step 450 if the coded representation belongs to the set of variable length codes. FIG. 5 illustrates an alternative exemplary chart for decoding the inter prediction mode according to one embodiment of the present invention. Two additional steps are incorporated in FIG. 5 to handle the case that the inter prediction mode does not belong to the selected set of mode names. In step 510, a pre-defined set of variable length codes for a second set of mode names corresponding to remaining mode names of the group of mode names that do not belong to the selected set of mode names is determined. The coded representation is decoded into the inter prediction mode according to the pre-defined set of variable length codes in step 520 if the coded representation belongs to the pre-defined set of variable length codes. The steps illustrated in the flow charts of FIG. 4 and FIG. 5 are examples to practice the invention. The processing order of the steps in FIG. 4 and FIG. 5 may be altered to practice the present invention.

In the disclosure herein, the statistics of inter prediction modes are collected from the previous slice and the set of variable length codes is determined for the subsequent slice (immediately following the previous slice) according to one embodiment of the present invention. According to another embodiment of the present invention, the statistics of inter prediction modes are updated for each coding unit and the variable length code for each mode is adjusted according to the statistics change during the coding process. According to another embodiment of the present invention, the variable length code for each mode is reset in the beginning of each slice. The reset code word table is either a predefined code word table for whole sequence or a code word table determined by the previous slice. Embodiment of video systems incorporating encoding or decoding of adaptive inter mode coding using variable length codes according to the present invention as described above may be implemented in various hardware, software codes, or a combination of both. For example, an embodiment of the present invention can be a circuit integrated into a video compression chip or program codes integrated into video compression software to perform the processing described herein. An embodiment of the present invention may also be program codes to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of coding inter prediction modes of coding units in video data, the method comprising:
receiving inter prediction modes corresponding to coding units in a video data set, wherein the inter prediction modes belong to a prediction mode set consisting of a group of mode names;
collecting statistics of the inter prediction modes associated with a selected set of mode names;
determining a set of variable length codes for the selected set of mode names according to the statistics; and
providing coded representation for each of the inter prediction modes by selecting one of the variable length codes corresponding to the mode name of said each of the inter prediction modes if the mode name of said each of the inter prediction modes belongs to the selected set of mode names.

2. The method of claim 1, wherein the video data set is selected from a group consisting of a slice, a group of slices, a frame, a group of pictures and a pre-defined video interval.

3. The method of claim 1, wherein the selected set of mode names include all elements of the group of mode names or a subset of the group of mode names, wherein the subset consists of at least two elements of the group of mode names.

4. The method of claim 1, wherein the set of variable length codes is updated according to the statistics that have been collected prior to a current inter prediction mode.

5. The method of claim 1, wherein the statistics are based on occurrence frequencies of the selected set of mode names corresponding to the inter prediction modes, and wherein the occurrence frequencies are collected using counters and each of the counters is associated with each of the selected set of mode names.

6. The method of claim 5, wherein the occurrence frequencies are updated by incrementing said each of the counters by 1 when a current inter prediction mode is equal to said each of the selected set of mode names after the current inter prediction mode is coded, and wherein the set of variable length codes is updated according to the occurrence frequencies updated.

7. The method of claim 6, wherein the counters are reset to pre-defined values substantially at beginning of a current video data set or at end of a previous video data set.

8. The method of claim 7, wherein the set of variable length codes is reset to a pre-defined table when the counters are reset.

9. The method of claim 5, wherein a first variable length code of the variable length codes associated with a first counter is swapped with a second variable length code of the variable length codes associated with a second counter when the first counter is larger than the second counter, wherein the first variable length code is longer than the second variable length code.

10. The method of claim 1, wherein the statistics are based on counts of consecutive occurrences of the selected set of mode names corresponding to the inter prediction modes, wherein the counts of consecutive occurrences are collected using counters and each of the counters is associated with each of the selected set of mode names, wherein the counters are reset to pre-defined values substantially at beginning of a current video data set or at end of a previous video data set.

11. The method of claim 10, wherein a first variable length code of the variable length codes associated with a first counter is swapped with a second variable length code of the variable length codes associated with a second counter when the first counter is larger than the second counter, wherein the first variable length code is longer than the second variable length code.

12. The method of claim 1, wherein the statistics are based on a combination of occurrence frequencies and counts of consecutive occurrences of the selected set of mode names corresponding to the inter prediction modes.

13. The method of claim 1, wherein the set of variable length codes is updated for each block set, wherein the block set is selected from a group consisting of a coding unit, a largest coding unit, and a group of coding units.

14. The method of claim 1, wherein separate statistics are collected for the inter prediction modes associated with each of selected coding unit depths, wherein the set of variable length codes is designed according to the separate statistics, and wherein the inter prediction modes associated with said each of the set of selected coding unit depths are coded using the set of variable length codes associated with said each of the selected coding unit depth.

15. The method of claim 14, wherein number of the selected coding unit depths is adaptively selected for the video data set.

16. The method of claim 1, wherein information associated with the set of variable length codes is incorporated in a slice header, Picture Parameter set (PPS) or Slice Parameter Set (SPS).

17. The method of claim 1, wherein the set of variable length codes corresponds to a set of codes generated using a unary codeword method.

18. The method of claim 1, wherein information associated with the selected set of mode names is incorporated in a slice header, Picture Parameter set (PPS) or Slice Parameter Set (SPS).

19. The method of claim 1, wherein a flag is incorporated in a slice header, PPS or SPS to indicate whether information associated with the set of variable length codes is incorporated in the slice header, PPS or SPS.

20. The method of claim 19, wherein a default set of variable length codes is selected if the flag indicates that no information associated with the set of variable length codes is incorporated in the slice header, PPS or SPS.

21. The method of claim 1 further comprising steps of:
determining a pre-defined set of variable length codes for the inter prediction modes belonging to a second set of mode names, wherein the second set of mode names includes remaining mode names of the group of mode names that do not belong to the selected set of mode names; and
providing the coded representation for said each of the inter prediction modes by selecting one of the pre-defined set of variable length codes corresponding to the mode name of said each of the inter prediction modes if the mode name of said each of the inter prediction modes belongs to the second set of mode names.

22. The method of claim 21, wherein a first variable length code corresponding to a first mode name associated with a current inter prediction mode is swapped with a second variable length code, wherein the second variable length code is a next shorter code of the first variable length code in the pre-defined set.

23. A method of decoding inter prediction modes of coding units, the method comprising:
determining a selected set of mode names from a bitstream;
determining a set of variable length codes for the selected set of mode names from the bitstream;
receiving coded representation for an inter prediction mode of a coding unit, wherein the inter prediction mode belong to a prediction mode set consisting of a group of mode names and the group of mode names includes the selected set of mode names;
decoding the coded representation into the inter prediction mode according to the set of variable length codes if the coded representation belongs to the set of variable length codes; and
updating the set of variable length codes for every coding unit, largest coding unit or a group of coding units according to the inter prediction mode decoded if the coded representation belongs to the set of variable length codes.

24. The method of claim 23 further comprising steps of:
determining a pre-defined set of variable length codes for a second set of mode names corresponding to remaining mode names of the group of mode names that do not belong to the selected set of mode names; and
decoding the coded representation into the inter prediction mode according to the pre-defined set of variable length codes if the coded representation belongs to the pre-defined set of variable length codes.

25. The method of claim 24, wherein a first variable length code corresponding to a first mode name associated with a current inter prediction mode decoded is swapped with a second variable length code, wherein the second variable length code is a next shorter code of the first variable length code in the pre-defined set.

26. The method of claim 23, wherein the selected set of mode names include all elements of the group of mode names or a subset of the group of mode names, wherein the subset consists of at least two elements of the group of mode names.

27. The method of claim 23, wherein occurrence frequencies of the selected set of mode names corresponding to the inter prediction modes decoded are collected using counters, and wherein each of the counters is associated with each of the selected set of mode names.

28. The method of claim 27, wherein the counters are reset to pre-defined values substantially at beginning of a current video data set or at end of a previous video data set, and wherein a video data set video data set is selected from a group consisting of a slice, a group of slices, a frame, a group of pictures and a pre-defined video interval.

29. The method of claim 28, wherein the set of variable length codes is reset to a pre-defined table when the counters are reset.

30. The method of claim 29, wherein a first variable length code of the variable length codes associated with a first counter is swapped with a second variable length code of the variable length codes associated with a second counter when the first counter is larger than the second counter, wherein the first variable length code is longer than the second variable length code.

31. The method of claim 23, wherein counts of consecutive occurrences of the selected set of mode names corresponding to the inter prediction modes decoded are collected using counters and each of the counters is associated with each of the selected set of mode names, wherein the counters are reset to pre-defined values substantially at beginning of a current video data set or at end of a previous video data set, and wherein a video data set video data set is selected from a group consisting of a slice, a group of slices, a frame, a group of pictures and a pre-defined video interval.

32. The method of claim 31, wherein a first variable length code of the variable length codes associated with a first counter is swapped with a second variable length code of the variable length codes associated with a second counter when the first counter is larger than the second counter, wherein the first variable length code is longer than the second variable length code.

33. The method of claim 23, wherein the set of variable length codes is associated with a coding unit depth, the coded representation for the inter prediction mode of the coding unit is decoded using the set of variable length codes associated with the coding unit depth.

34. The method of claim 23, wherein the set of variable length codes corresponds to a set of codes generated using a unary codeword method.

35. An apparatus of coding inter prediction modes of coding units in video data, the apparatus comprising:
means for receiving inter prediction modes corresponding to coding units in a video data set, wherein the inter prediction modes belong to a prediction mode set consisting of a group of mode names;
means for collecting statistics of the inter prediction modes associated with a selected set of mode names;
means for determining a set of variable length codes for the selected set of mode names according to the statistics; and
means for providing coded representation for each of the inter prediction modes by selecting one of the variable length codes corresponding to the mode name of said each of the inter prediction modes if the mode name of said each of the inter prediction modes belongs to the selected set of mode names.

36. The apparatus of claim 35, wherein the statistics are based on occurrence frequencies of the selected set of mode names corresponding to the inter prediction modes, and wherein the occurrence frequencies are collected using counters and each of the counters is associated with each of the selected set of mode names.

37. The apparatus of claim 36, wherein a first variable length code of the variable length codes associated with a first counter is swapped with a second variable length code of the variable length codes associated with a second counter when the first counter is larger than the second counter, wherein the first variable length code is longer than the second variable length code.

38. The apparatus of claim 35, wherein the set of variable length codes is updated for each block set, wherein the block set is selected from a group consisting of a coding unit, a largest coding unit, and a group of coding units.

39. The apparatus of claim 35, wherein separate statistics are collected for the inter prediction modes associated with each of selected coding unit depths, wherein the set of variable length codes is designed according to the separate statistics, and wherein the inter prediction modes associated with said each of the set of selected coding unit depths are coded using the set of variable length codes associated with said each of the selected coding unit depth.

40. The apparatus of claim 35, wherein a pre-defined set of variable length codes is used for the inter prediction modes belonging to a second set of mode names, wherein the second set of mode names includes remaining mode names of the group of mode names that do not belong to the selected set of mode names.

41. An apparatus of decoding inter prediction modes of coding units, the apparatus comprising:
means for determining a selected set of mode names from a bitstream;
means for determining a set of variable length codes for the selected set of mode names from the bitstream;
means for receiving coded representation for an inter prediction mode of a coding unit, wherein the inter prediction mode belong to a prediction mode set consisting of a group of mode names and the group of mode names includes the selected set of mode names;
means for decoding the coded representation into the inter prediction mode according to the set of variable length codes if the coded representation belongs to the set of variable length codes; and
means for updating the set of variable length codes for every coding unit, largest coding unit or a group of coding units according to the inter prediction mode decoded if the coded representation belongs to the set of variable length codes.

42. The apparatus of claim 41 further comprising:
means for determining a pre-defined set of variable length codes for a second set of mode names corresponding to remaining mode names of the group of mode names that do not belong to the selected set of mode names; and
means for decoding the coded representation into the inter prediction mode according to the pre-defined set of variable length codes if the coded representation belongs to the pre-defined set of variable length codes.

43. The apparatus of claim 41, wherein occurrence frequencies of the selected set of mode names corresponding to the inter prediction modes decoded are collected using counters, and wherein each of the counters is associated with each of the selected set of mode names.

44. The apparatus of claim 41, wherein the set of variable length codes is associated with a coding unit depth, the coded representation for the inter prediction mode of the coding unit is decoded using the set of variable length codes associated with the coding unit depth.
